(19) United States
(12) Patent Application Publication
(10) Pub. No.: US 2022/0240460 A1
(43) Pub. Date: Aug. 4, 2022

(54) ROTARY LIQUID-SUPPLYING CULTIVATION DEVICE FOR PLANT GROWTH

(71) Applicant: Cho Yee NG, Hong Kong (HK)

(72) Inventor: Cho Yee NG, Hong Kong (HK)

(21) Appl. No.: 17/648,496

(22) Filed: Jan. 20, 2022

(30) Foreign Application Priority Data
Jan. 29, 2021 (CN) 202110125735.7

(51) Int. Cl. A01G 9/24

(52) U.S. Cl. CPC A01G 9/247; A01G 9/249

(57) ABSTRACT

A rotary liquid-supplying cultivation device for plant growth is provided, which includes a box body provided with a water tank, a liquid supply device and a rotating device. A fill lamp is connected with an inner wall of the box body. The liquid supply device includes a liquid supply pipe, a solenoid valve, a sleeve, a first spring, a bushing, a metal pipe, a cannula and a cultivation basin. An end of the liquid supply pipe is inserted in the water tank; a limiting block is arranged in the sleeve and slidably matched with an inner wall of the sleeve; two ends of the first spring are respectively connected with the limiting block and the bushing. The rotating device includes a turntable on which the cultivation basin is arranged, a transmission rod coaxially connected with the metal tube and a driving mechanism configured to drive the transmission rod to rotate.

### CROSS-REFERENCE TO RELATED APPLICATIONS

This is a U. S. patent application which claims the priority and benefit of Chinese Patent Application Number 202110125735.7, filed on Jan. 29, 2021, the disclosure of which is incorporated herein by reference in its entirety.

### TECHNICAL FIELD

The disclosure relates to a technical field of plant cultivation, in particular to a rotary liquid-supplying cultivation device for plant growth.

### BACKGROUND ART

In plant cultivation, for some plants that need special cultivation, a plant incubator is usually used to cultivate the plants, and the incubator provides a better growing environment for the plants. Generally, a fluorescent lamp is used in an ordinary incubator to provide light for the plants, but when the fluorescent lamp illuminate the plants, the plants receive uneven light because there are many cultivated plants in the incubator, which easily leads to great differences in plant growth and inconvenient operations in watering the plants in the incubator.

### SUMMARY

Embodiments of this disclosure aims to provide a rotary liquid-supplying cultivation device for plant growth, which can conveniently irrigate cultivated plants at different positions in an incubator and can improve uneven light reception of the plants.

Embodiments of the disclosure can be realized as follows.

A rotary liquid-supplying cultivation device for plant growth is provided in an embodiment of the disclosure, which includes a box body, a liquid supply device and a rotating device.

A water tank with a water inlet and a water outlet is provided at an upper end of the box body, and a fill lamp is connected with an inner wall of the box body.

The liquid supply device includes a liquid supply pipe, a solenoid valve, a sleeve, a first spring, a bushing, a metal tube, a plurality of cannulas and a plurality of cultivation basins. An end of the liquid supply pipe is inserted in the water tank, the solenoid valve is installed at the liquid supply pipe, one end of the sleeve is connected with the liquid supply pipe and the other end of the sleeve is connected with the metal tube, and the liquid supply pipe, the sleeve and the metal tube are all communicated with each other, and a lower end of the liquid supply pipe is connected with a stop block which is arranged in the sleeve and slidably matched with an inner wall of the sleeve. The first spring is arranged in the sleeve, and two ends of the first spring are respectively connected with the stop block and the bushing, and the bushing is arranged in the metal tube. The plurality of cannulas are communicated with that metal tube. The plurality of cannulas are movably plugged into a plurality of cultivation basins respectively.

The rotating device includes a turntable, a transmission rod and a driving mechanism. The turntable is fixedly sleeved on the metal tube, the cultivation basins are arranged on the turntable, the transmission rod is coaxially connected with the metal tube, and the driving mechanism is configured to drive the transmission rod to rotate.

Further, the driving mechanism includes a supporting plate, a motor and a water collecting tray. The motor is fixedly installed on the supporting plate, the supporting plate is fixed inside the box body, a rotating shaft of the motor is coaxially connected with the transmission rod, the transmission rod movably penetrates through the supporting plate, and an outer wall of the transmission rod is sleeved with a limiting ring which is connected with the supporting plate. The water collecting tray is sleeved on the outer wall of the transmission rod, and the water collecting tray is arranged between the turntable and the supporting plate.

Further, a lower end of the supporting plate is fixedly connected with a bracket, a bottom of the box body is provided with a guide groove, and the bracket and the guide groove can be slidably matched with each other.

Further, an end of the bracket is connected with a limiting rod, the inner wall of the box body is provided with a clamping seat, the clamping seat is provided with a limiting groove, the limiting rod can be slidably matched with the limiting groove, and the limiting rod can be fixed on the clamping seat through a positioning pin.

Further, the rotary liquid-supplying cultivation device for plant growth further includes a controller. The fill lamp is connected with the controller through a wire, and both the motor and the solenoid valve are connected with the controller through wires.

Further, the box body is provided with a vent, and an air pump is provided inside the box body, the vent is connected with the air pump, and the air pump is electrically connected with the controller.

Further, a lower end of each of the cultivation basin is connected with a sliding block and the turntable is provided with a sliding groove, and the sliding block and the sliding groove can be slidably matched with each other.

Further, an outer side wall of the cultivation basin is connected with a shell, a positioning rod is slidingly sleeved inside the shell, a second spring and a collar are sleeved in an outer side wall of the positioning rod, the second spring and the collar are both installed in the shell, the second spring is connected with the collar, and the collar is disposed closer to the turntable. The turntable is provided with a positioning hole, and the positioning rod can be fixed to the positioning hole.

Further, both a water inlet and a water outlet are provided with end caps, and the end caps are threadedly connected with the water inlet and the water outlet.

The rotary liquid-supplying cultivation device for plant growth in the embodiment of the disclosure provides advantages that:

When an end of the liquid supply pipe is inserted into the water tank, the water in the water tank can enter the bushing from the liquid supply pipe and then enter the metal pipe from the bushing. The transmission rod can be driven by the driving mechanism to rotate, and rotation of the transmission rod drives the metal pipe to rotate. During rotation of the metal pipe, the liquid supply pipe and the bushing rotate with the metal pipe, and rotation of the metal pipe brings the turntable to rotate. During rotation of the turntable, the cultivation basins on the turntable moves with it. Each of the cannulas crosses the metal tube and is communicated with the metal tube, and the cannula is movably plugged into the cultivation basin, so that water can enter the cannula from the metal tube and then enter a plurality of cultivation basins to irrigate the plants in the cultivation basins, thereby irrigating the plants at different positions. The driving mechanism drives the transmission rod to rotate, and the cultivation basin rotates with the turntable, so that the plants in a plurality of cultivation basins can receive illumination of the fill lamp during rotation of the turntable, and uneven light reception of plants can be improved.

### BRIEF DESCRIPTION OF THE DRAWINGS

In order to illustrate technical schemes of embodiments of this application more clearly, the following drawings used in the embodiments will be briefly introduced; it should be understood that the following drawings only show some embodiments of this application, therefore they should not be regarded as a limiting of the protection scope; and other related drawings can be obtained according to these ones without creative effort for ordinary skilled in the art.

FIG. 1 is a schematic diagram of an overall structure of a rotary liquid-supplying cultivation device for plant growth according to an embodiment of this disclosure;

FIG. 2 is a structural diagram of a turntable according to an embodiment of this disclosure;

FIG. 3 is a schematic structural diagram of a rotating device according to an embodiment of this disclosure;

FIG. 4 is a partial structural schematic diagram of a liquid supply device according to an embodiment of this disclosure;

FIG. 5 is a structural diagram of a turntable according to an embodiment of this disclosure;

FIG. 6 is a structural diagram of a turntable according to an embodiment of this disclosure;

FIG. 7 is an enlarged view of area A in FIG. 5.

Reference Number: 1 Box Body; 11 Guide Groove; 12 Vent; 2 Box Door; 3 Water Tank; 31 Water Inlet; 32 Water Outlet; 4 Fill Lamp; 5 Rotating Device; 51 Supporting Plate; 52 Bracket; 53 Limiting Rod; 54 Clamping Seat; 55 Limiting Groove; 56 Positioning Pin; 57 Motor; 58 Transmission Rod; 59 Limiting Ring; 510 Water Collecting Tray; 511 Drain; 6 Liquid Supply Device; 61 Liquid Supply Pipe; 62 Solenoid Valve; 63 Sleeve; 64 Bushing; 65 Stop Block; 66 First Spring; 67 Metal Pipe; 68 Cannula; 69 Cultivation basin; 610 Sliding Block; 611 Shell; 612 Positioning Rod; 613 Second Spring; 614 Collar; 615 Turntable; 616 Sliding Groove; 617 Positioning Hole; 7 Switch.

### DETAILED DESCRIPTION

In order to make the purposes, technical schemes and advantages of embodiments of this disclosure more clear, the technical schemes in the embodiments of this disclosure will be described clearly and completely with reference to the drawings in the embodiments of this disclosure; and it is Obvious that the described embodiments are part of the embodiments of this disclosure, but not all of them. The components of the embodiments of the application generally described and illustrated in the drawings herein can be arranged and designed in various different configurations.

Therefore, the following detailed description of the embodiments of the application provided in the drawings is not intended to limit the claimed scope of the application, but only shows selected embodiments of the application. On a basis of the embodiments in this application, all other embodiments obtained by the ordinary skilled in the art without any creative effort are within the protection scope of this application.

In the description of this application, it should be noted that the orientation or position relationships indicated by the terms such as “inner” and “outer” are based on the orientation or position relationships shown in the drawings, or the generally adopted orientation or position relationships when the products of this application are used are only for convenience of describing this application and for simplifying the description, but do not indicate or imply that the referred device or element must have a specific orientation, be constructed and operated in a specific orientation, and therefore cannot be understood as a limitation of this application. In addition, the terms “first”, “second”, etc. are only used to distinguish descriptions, and cannot be understood as indicating or implying a relative importance.

In the description of this application, it should also be noted that unless otherwise specified and limited, the terms “providing”, “installing” and “connecting” should be understood in a broad sense, for example, it can be “fixedly connecting”, or “detachably connecting” or “integrally connecting”, or it can be “mechanically connecting” or “electrically connecting”, or it can be “directly connecting” or “indirectly connecting through an intermediate medium”, or it can be “communicating within two elements”. For those ordinary skilled in the art, the specific meanings of the above terms in this application can be understood according to specific situations.

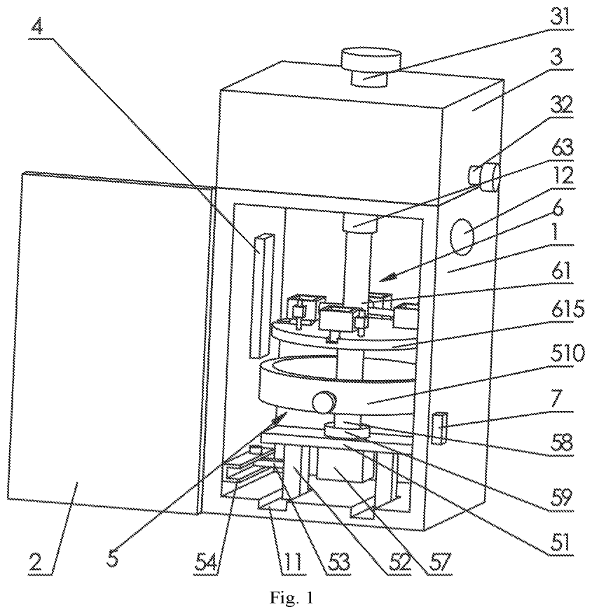

Referring to FIG. 1, a rotary liquid-supplying cultivation device for plant growth is provided in an embodiment of the disclosure, which includes a box body 1, a liquid supply device 6 and a rotating device 5.

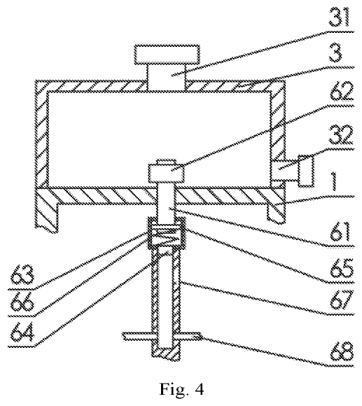

Referring to FIGS. 1 and 4, a water tank 3 with a water inlet 31 and a water outlet 32 is provided at an upper end of the box body 1, and a fill lamp 4 is connected with an inner wall of the box body 1. Illustratively, both the water inlet 31 and the water outlet 32 are provided with end caps which are threadedly connected with the water inlet 31 and the water outlet 32.

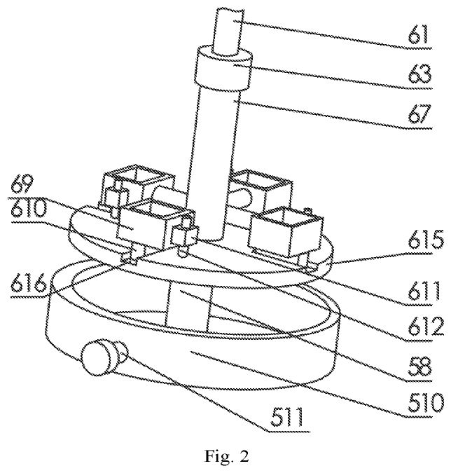

Referring to FIGS. 2 and 4, the liquid supply device 6 includes a liquid supply pipe 61, a solenoid valve 62, a sleeve 63, a first spring 66, a bushing 64, a metal tube 67, a plurality of cannulas 68 and a plurality of cultivation basins 69. An end of the liquid supply pipe 61 is inserted in the water tank 3, the solenoid valve 62 is installed at the liquid supply pipe 61, one end of the sleeve 63 is connected with the liquid supply pipe 61 and the other end of the sleeve is connected with the metal tube 67, and the liquid supply pipe 61, the sleeve 63 and the metal tube 67 are all communicated with each other, and a lower end of the liquid supply pipe 61 is connected with a stop block 65 which is arranged in the sleeve 63 and slidably matched with an inner wall of the sleeve 63. The first spring 66 is arranged in the sleeve 63, and two ends of the first spring 66 are respectively connected with the stop block 65 and the bushing 64, and the bushing 64 is arranged in the metal tube 67. The plurality of cannulas 68 are communicated with that metal tube 67. The plurality of cannulas 68 are movably plugged into a plurality of cultivation basins 69 respectively.

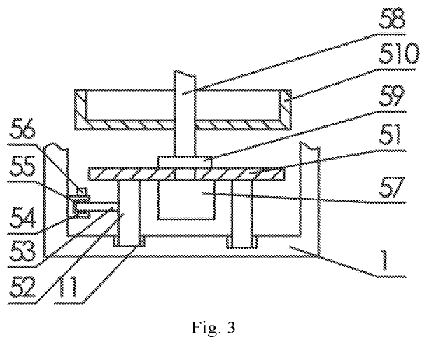

Referring to FIGS. 2 and 3, the rotating device 5 includes a turntable 615, a transmission rod 58 and a driving mechanism. The turntable 615 is fixedly sleeved on the metal tube 67, the cultivation basins 69 are arranged on the turntable 615, the transmission rod 58 is coaxially connected with the metal tube 67, and the driving mechanism is configured to drive the transmission rod 58 to rotate.

When an end of the liquid supply pipe 61 is inserted into the water tank 3, the water in the water tank 3 can enter the bushing 64 from the liquid supply pipe 61 and then enter the metal pipe 67 from the sleeve 64. The transmission rod 58 can be driven by the driving mechanism to rotate, and rotation of the transmission rod 58 drives the metal pipe 67 to rotate. During rotation of the metal pipe 67, the liquid supply pipe 61 and the bushing 64 rotate with the metal pipe, and rotation of the metal pipe 67 brings the turntable 615 to rotate. During rotation of the turntable 615, the cultivation basins 615 on the turntable 69 moves with it. Each of the cannulas 68 crosses the metal tube 67 and is communicated with the metal tube 67, and the cannula 68 is movably plugged into the cultivation basin 69, so that water can enter the cannula 68 from the metal tube 67 and then enter a plurality of cultivation basins 69 to irrigate the plants in the cultivation basins 69, thereby irrigating the plants at different positions. The driving mechanism drives the transmission rod 58 to rotate, and the cultivation basin 69 rotates with the turntable 615, so that the plants in a plurality of cultivation basins 69 can receive illumination of the fill lamp 4 during rotation of the turntable 615, and uneven light reception of plants can be improved.

Referring to FIGS. 1 and 2, illustratively, a lower end of the cultivation basin 69 is connected with a sliding block 610, and the turntable 615 is provided with a sliding groove 616, and the sliding block 610 and the sliding groove 616 can be slidably matched with each other.

A position of the cultivation basin 69 on the turntable 615 can be adjusted by slidingly fitting between the sliding block 610 and the sliding groove 616.

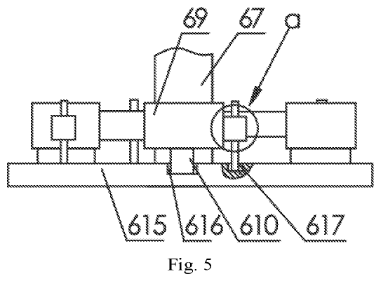

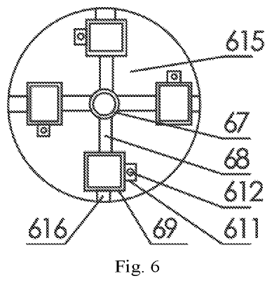

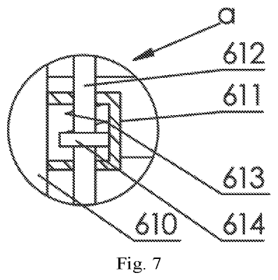

Referring to FIGS. 5 to 7, further, an outer side wall of the cultivation basin 69 is connected with a shell 611, a positioning rod 612 is slidingly sleeved inside the shell 611, a second spring 613 and a collar 614 are sleeved in an outer side wall of the positioning rod 612, the second spring 613 and the collar 614 are both installed in the shell 611, the second spring 613 is connected with the collar 614, and the collar 614 is disposed closer to the turntable 615. The turntable 615 is provided with a positioning hole 617, and the positioning rod 612 can be fixed to the positioning hole 617.

By fixing the positioning rod 612 to the positioning hole 617, the cultivation basin 69 can be fixed. The second spring 613 is connected with the collar 614. The collar 614 is disposed closer to the turntable 615. When the positioning rod 612 is fixed in the positioning hole 617, the second spring 613 is in a normal state; and when the positioning rod 612 is separated from the positioning hole 617, the second spring 613 is in a compressed state. The second spring 613 in the compressed state exerts a downward force on the collar 614, which urges the positioning rod 612 to be inserted into the positioning hole 617, thus enabling the cultivation basin 69 to be better fixed on the turntable 615.

Further, the driving mechanism includes a supporting plate 51, a motor 57 and a water collecting tray 510. The motor 57 is fixedly installed on the supporting plate 51, a rotating shaft of the motor 57 is coaxially connected with the transmission rod 58, the transmission rod 58 movably penetrates through the supporting plate 51, and an outer wall of the transmission rod 58 is sleeved with a limiting ring 59 which is connected with the supporting plate 51. The water collecting tray 510 is sleeved on the outer wall of the transmission rod 58, and the water collecting tray 510 is arranged between the turntable 615 and the supporting plate 51.

The supporting plate 51 is fixed inside the box body 1, and the supporting plate 51 provides support for the motor 57. The motor 57 can drive the transmission rod 58 to rotate. The water collecting tray 510 also rotates as the transmission rod 58 rotates. If the water collecting tray 510 is arranged between the turntable 615 and the supporting plate 51, the water collecting tray 510 can collect the water dripping from the cultivation basin 69, thus preventing the water from affecting the motor 57. The limit ring 59 can limit radial movement of the transmission rod 58, which is more stable and will not shake when rotating. Illustratively, the motor 57 is connected with the switch 7 through a wire, and the switch 7 is arranged on an outer wall of the box body 1.

Referring to FIGS. 1 and 3, further, a lower end of the supporting plate 51 is fixedly connected with a bracket 52, a bottom of the box body 1 is provided with a guide groove 11, and the bracket 52 and the guide groove 11 can be slidably matched with each other.

Then, by moving the supporting plate 51 to slide along the guide groove 11, a position of the supporting plate 51 in the box body 1 can be adjusted, which is convenient for installation.

Further, an end of the bracket 52 is connected with a limiting rod 53, the inner wall of the box body 1 is provided with a clamping seat 54, the clamping seat 54 is provided with a limiting groove 55, the limiting rod 53 can be slidably matched with the limiting groove 55, and the limiting rod 53 can be fixed on the clamping seat 54 through a positioning pin 56.

When the supporting plate 51 slides along the guide groove 11, the limiting rod 53 can be slidably matched with the limiting groove 55. If the limiting rod 53 is fixed to the clamping seat 54 by using the positioning pin 56, the supporting plate 51 can be fixed at a certain position.

In a possible implementation, the rotary liquid-supplying cultivation device for plant growth further includes a controller. The fill lamp 4 is connected with the controller through a wire, and the solenoid valve 62 is connected with the controller through a wire.

The solenoid valve 62 can be controlled by the controller to adjust a liquid supply flow, which can be operated quickly and easily. In addition, the fill light 4 can be controlled to turn on or off by the controller.

Optionally, the box body 1 is provided with a vent 12, and an air pump is provided inside the box body 1, the vent 12 is connected with the air pump, and the air pump is electrically connected with the controller.

The air pump is controlled by the controller to blow inside the box body 1, so that air inside the box body 1 circulates, and finally the air is exhausted from the vent 12.

To sum up, in the rotary liquid-supplying cultivation device for plant growth in the embodiments of this disclosure, the transmission rod 58 can be driven by the driving mechanism to rotate, and rotation of the transmission rod 58 drives the metal pipe 67 to rotate. During rotation of the metal pipe 67, the liquid supply pipe 61 and the bushing 64 rotate with the metal pipe, and rotation of the metal pipe 67 brings the turntable 615 to rotate. During rotation of the turntable 615, the cultivation basins 615 on the turntable 69 moves with it. Each of the cannulas 68 crosses the metal tube 67 and is communicated with the metal tube 67, and the cannula 68 is movably plugged into the cultivation basin 69, so that water can enter the cannula 68 from the metal tube 67 and then enter a plurality of cultivation basins 69 to irrigate the plants in the cultivation basins 69, thereby irrigating the plants at different positions. The driving mechanism drives the transmission rod 58 to rotate, and the cultivation basin 69 rotates with the turntable 615, so that the plants in a plurality of cultivation basins 69 can receive illumination of the fill lamp 4 during rotation of the turntable 615, and uneven light reception of plants can be improved.

The above is only preferred embodiments of this application, and is not intended to limit this application, and modifications and variations can be made in this application for those skilled in the art. Any modification, equivalent substitution, improvement, etc. made within the spirit and principle of this disclosure shall be encompassed within the protection scope of this disclosure.

What is claimed is:

1. A rotary liquid-supplying cultivation device for plant growth, comprising:
a box body, water tank with a water inlet and a water outlet being provided at an upper end of the box body and a fill lamp being connected with an inner wall of the box body;
a liquid supply device comprising a liquid supply pipe, a solenoid valve, a sleeve, a first spring, a bushing, a metal tube, a plurality of cannulas and a plurality of cultivation basins, wherein an end of the liquid supply pipe is inserted in the water tank, the solenoid valve is installed at the liquid supply pipe, one end of the sleeve is connected with the liquid supply pipe and the other end of the sleeve is connected with the metal tube, and the liquid supply pipe, the sleeve and the metal tube are all communicated with each other, and a lower end of the liquid supply pipe is connected with a stop block which is arranged in the sleeve and slidably matched with an inner wall of the sleeve; the first spring is arranged in the sleeve, and two ends of the first spring are respectively connected with the stop block and the bushing, and the bushing is arranged in the metal tube; the plurality of cannulas are communicated with that metal tube; the plurality of cannulas are movably plugged into a plurality of cultivation basins respectively; and
a rotating device comprising a turntable, a transmission rod and a driving mechanism, wherein the turntable is fixedly sleeved on the metal tube, the cultivation basins are arranged on the turntable, the transmission rod is coaxially connected with the metal tube, and the driving mechanism is configured to drive the transmission rod to rotate.

2. The rotary liquid-supplying cultivation device for plant growth according to claim 1, wherein the driving mechanism comprises a supporting plate, a motor and a water collecting tray, the motor being fixedly installed on the supporting plate, the supporting plate being fixed inside the box body, a rotating shaft of the motor being coaxially connected with the transmission rod, the transmission rod movably penetrating through the supporting plate, and an outer wall of the transmission rod being sleeved with a limiting ring which is connected with the supporting plate; the water collecting tray being sleeved on the outer wall of the transmission rod, and the water collecting tray being arranged between the turntable and the supporting plate.

3. The rotary liquid-supplying cultivation device for plant growth according to claim 2, wherein a lower end of the supporting plate is fixedly connected with a bracket, a bottom of the box body is provided with a guide groove, and the bracket and the guide groove can be slidably matched with each other.

4. The rotary liquid-supplying cultivation device for plant growth according to claim 3, wherein an end of the bracket is connected with a limiting rod, the inner wall of the box body is provided with a clamping seat, the clamping seat is provided with a limiting groove, the limiting rod can be slidably matched with the limiting groove, and the limiting rod is fixed on the clamping seat through a positioning pin.

5. The rotary liquid-supplying cultivation device for plant growth according to claim 2, further comprising a controller, the fill lamp being connected with the controller through a wire, and the solenoid valve being connected with the controller through a wire.

6. The rotary liquid-supplying cultivation device for plant growth according to claim 5, wherein the box body is provided with a vent, and an air pump is provided inside the box body, the vent is connected with the air pump, and the air pump is electrically connected with the controller.

7. The rotary liquid-supplying cultivation device for plant growth according to claim 2, wherein the water collecting tray is provided with a drain, and the drain is provided with an end cap which is threadedly connected with the drain.

8. The rotary liquid-supplying cultivation device for plant growth according to claim 1, wherein a lower end of each of the cultivation basin is connected with a sliding block and the turntable is provided with a sliding groove, the sliding block and the sliding groove being slidably matched with each other.

9. The rotary liquid-supplying cultivation device for plant growth according to claim 8, wherein an outer side wall of the cultivation basin is connected with a shell, a positioning rod is slidingly sleeved inside the shell, a second spring and a collar are sleeved in an outer side wall of the positioning rod, the second spring and the collar are both installed in the shell, the second spring is connected with the collar, and the collar is disposed closer to the turntable; the turntable is provided with a positioning hole, and the positioning rod can be fixed to the positioning hole.

10. The rotary liquid-supplying cultivation device for plant growth according to claim 1, wherein both the water inlet and the water outlet are provided with end caps, and the end caps are threadedly connected with the water inlet and the water outlet.
